(19) United States
(12) Patent Application Publication
(10) Pub. No.: US 2018/0012230 A1
(43) Pub. Date: Jan. 11, 2018

(54) EMOTION DETECTION OVER SOCIAL MEDIA

(71) Applicant: International Business Machines Corporation, Armonk, NY (US)

(72) Inventors: Guy Feigenblat, Givataym (IL); Jonathan Herzig, Tel-Aviv (IL); David Konopnicki, Haifa (IL); Michal Shmueli-Scheuer, Tel-Aviv (IL)

(21) Appl. No.: 15/206,518

(22) Filed: Jul. 11, 2016

(51) Int. Cl. G06Q 30/00; G06Q 50/00

(52) U.S. Cl. CPC G06Q 30/016; G06Q 50/01

(57) ABSTRACT

Embodiments of the present invention provide systems and methods for detecting emotions with social media settings. Integral-based, emotion-based, and temporal-based features are used to assess the context of a dialogue between two parties. Social media features and textual features are also considered in order to detect the emotions of a party by assessing the popularity of the party and non-contextual factors within the dialogue, respectively.

### BACKGROUND OF THE INVENTION

The present invention relates generally to the field of social media programs, and more specifically to detecting emotions within social media programs.

Social media programs are tools employed by business enterprises as a way to transition into becoming more open, innovative, and agile entities. While business enterprises are using social media programs to assist in productivity, individuals are using social media programs for personal use, and to manage personal tasks, professional projects, and social networks. The events, which influence workers on a daily basis, are typically huge and growing on a day-by-day basis. The application of social media programs aims to facilitate the efficient flow of information and knowledge between people without hierarchical barriers in order to complete these required tasks on a daily basis.

### SUMMARY

According to one embodiment of the present invention, a method for detecting emotions within social media programs is provided, the method comprising the steps of: collecting, by one or more processors, contents of a dialogue between a first party and a second party; extracting, by one or more processors, a plurality of features from the contents of the dialogue; and analyzing, by one or more processors, the extracted plurality of features in order to make one or more determinations of a first emotion associated with the first party and a second emotion associated with the second party.

Another embodiment of the present invention provides a computer program product for detecting emotions within social media programs, based on the method described above.

Another embodiment of the present invention provides a computer system for detecting emotions within social media programs, based on the method described above.

### BRIEF DESCRIPTION OF THE DRAWINGS

FIG. 1 is a functional block diagram illustrating a data processing environment, in accordance with an embodiment of the present invention;

FIG. 2 is functional block diagram illustrating a list of turns, in accordance with an embodiment of the present invention;

FIG. 3 is a functional block diagram illustrating a dialogue model, in accordance with an embodiment of the present invention;

FIG. 4 is an operational flowchart depicting the steps performed by a dialogue program in order to detect emotions in a dialogue, in accordance with an embodiment of the present invention; and

FIG. 5 depicts a block diagram of internal and external components of a computing device, in accordance with an embodiment of the present invention.

### DETAILED DESCRIPTION

Providing customer support through social media channels is gaining increasing popularity among business enterprises. In such instances, automatic detection and analysis of the emotions expressed by customers during the dialogue may prove to be of high probative value to business enterprises. Furthermore, the result of such an analysis of emotions can be applied in assessing the quality of the customer support provided, inform agents (working for the business enterprises) about desirable responses, and develop automated service agents for social media interactions. Embodiments of the present invention disclose methods and systems to improve the detection of emotions in social media customer service dialogues via the application of: (i) text based turn features; (ii) dialogue features; and (iii) social media features.

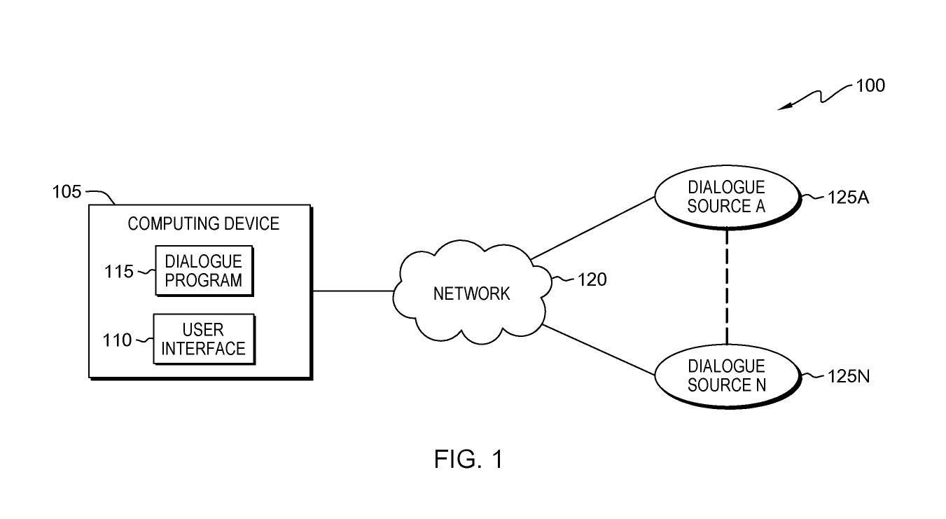

The present invention will now be described in detail with reference to the Figures. FIG. 1 is a functional block diagram illustrating a data processing environment, generally designated 100, in accordance with one embodiment of the present invention. FIG. 1 provides only an illustration of implementation and does not imply any limitations with regard to the environments in which different embodiments may be implemented. Modifications to data processing environment 100 may be made by those skilled in the art without departing from the scope of the invention as recited by the claims. In this exemplary embodiment, data processing environment 100 includes dialogue sources 125A-N and computing device 105 connected by network 120.

Dialogue sources 125A-N are sources of information/data amenable to processing by dialogue program 115. The number of dialogue sources 125A-N may vary depending on the user and can be processed in a parallel, efficient, and scalable fashion. Customers use dialogue sources 125A-N to communicate with computing device 105. Dialogue sources 125A-N may be devices, which are not limited to a personal computer, cell phone, or other computing device; e-mails; text messages; to-do lists associated with software applications; cloud-based applications; social networks services (i.e., platforms to build social relations or social networks among people using a particular platform); and social media (i.e., computer-mediated tools which allow people to create, share, or exchange information in virtual communities and networks). Sources of dialogues may derive from applications that belong to a collaboration platform (i.e., a category of business software which adds broad networking capabilities to work processes) within a social media setting.

Network 120 can be, for example, a local area network (LAN), a wide area network (WAN) such as the Internet, or a combination of the two, and can include wired, wireless, or fiber optic connections. In general, network 120 can be any combination of connections and protocols which support communication between computing device 105 and dialogue sources 125A-N. Network 120 connects dialogue sources 125A-N and computing device 105 to social media programs or other types of computer-mediated tools which allow people or organizations to create, share, and/or exchange information, ideas, images, videos, etc. in virtual networks and communities.

User interface 110 may be for example, a graphical user interface (GUI) or a web user interface (WUI) and can display text, documents, web browser windows, user options, application interfaces, instructions for operation, and the information (such as graphics, text, and sound) a program presents to a user and the control sequences the user employs to control the program. User interface 110 is capable of receiving data, user commands, and data input modifications from a user and is capable of communicating with dialogue program 115.

Dialogue program 115 behaves as a dialogue engine to facilitate a conversation between a computing device 105 and dialogue sources 125A-N. The dialogue engine functionality of dialogue program 115 is able to: (i) control the flow of a dialogue (i.e., “actions”); and (ii) detect the emotional state of the customer (i.e., users of dialogue sources 125A-N) during the conversation (i.e., “emotions”). Dialogue program 115 adapts to shifts in a dialogue between a customer (i.e., a user of dialogue sources 125A-N) and the business (i.e., the user of computing device 105). The dialogue engine functionality may handle many environments including a web-based dialogue such as those dialogues which take place over a social media platform. Thus, given an input of customer care dialogue turns (i.e., “back and forth” dialogue between the customer and the business) in the social media setting, dialogue program 115 analyzes a set of unique features, as presented/displayed over social media, in order to detect emotions from the customer input. These unique features are analyzed and separated into three features sets—dialogue, social, and textual feature sets. More specifically, dialogue program 115 performs analytics on the context of the dialogue to extract and compile informative features as dialogue features for emotion classifications in written dialogues. These contexts are the circumstances which form the setting of statements or ideas that can be fully understood and assessed. Dialogue program 115 is able to process and assess the context of a statement by considering other factors in addition to the actual dialogue. For example, a portion of dialogue over a social media setting is attributed to the customer, wherein the customer states “this is the greatest product ever.” Based on only the text in the dialogue, the customer seems satisfied with the product. However, dialogue program 115 analyzes the full context of the conversation. The customer's statement over the social media setting took place in a chat room for customers upset with the performance of a product looking for technical assistance. Dialogue program 115 assesses and analyzes the dialogue and determines the customer's statement is a sarcastic remark indicative of the customer having the emotion of dissatisfaction. Furthermore, the dialogue features incorporate and include: (i) integral features such as the dialogue's topic; and (ii) emotional features (e.g., expressed emotions the parties participating in a dialogue expressed in previous turns). Responsive to performing analytics on social media content, dialogue program 115 extracts social features (e.g., the number of followers in the social media) and temporal features (e.g., a customer service agent's response time).

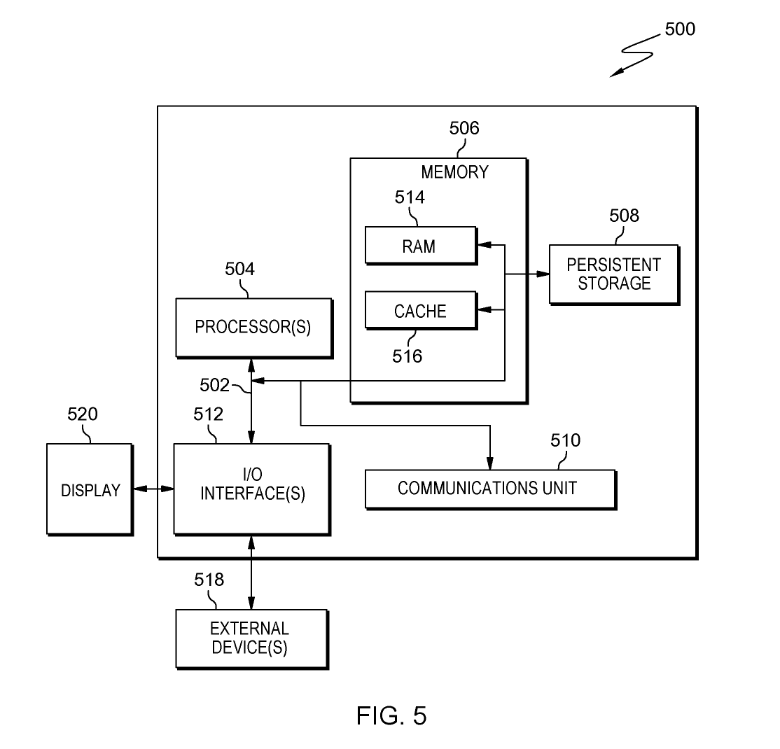

Computing device 105 includes dialogue program 115 and user interface 110. Computing device 105 is in use by a business which provides customer service to the users of dialogue source 125A-N. Computing device 105 may be a laptop computer, a tablet computer, a netbook computer, a personal computer (PC), a desktop computer, a personal digital assistant (PDA), a smart phone, a thin client, or any programmable electronic device capable of communicating with dialogue sources 125A-N. Dialogue sources 125A-N can be processed by computing device 105 over one or more servers, which is not shown in the drawing. Additionally, there can be multiple computing devices 105, each associated with a unit of dialogue sources 125A-N processed in parallel. Computing device 105 may include internal and external hardware components, as depicted and described in further detail with respect to FIG. 5.

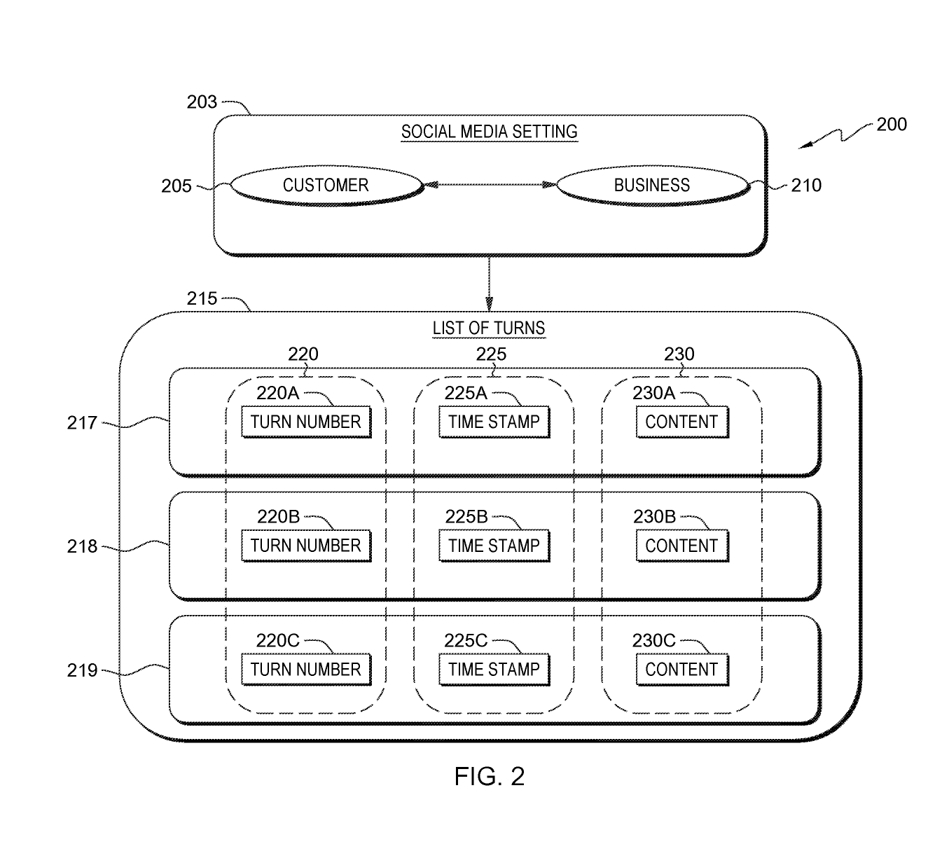

FIG. 2 is functional block diagram illustrating a list of turns, in accordance with an embodiment of the present invention.

Environment 200 depicts the resulting tuples from a dialogue between customer 205 and business 210 within social media setting 203. In an exemplary embodiment, social media setting 203 is a social networking site. For example, customer 205 is communicating with business 210 over social media setting 203 in order to obtain customer service support regarding the configuration of a stock trading program. Customer 205 and business 210 are two parties communicating with each other in a back-and-forth fashion. This back-and-forth fashion communication is described in terms of turns. A turn refers to a point in the dialogue where the first party communicates with the second party and the subsequent turn refers to another point in the dialogue where the second party responds to the first party. The dialogue is analyzed by dialogue program 115 to furnish list of turns 215. List of turns 215 is an ordered list of turns [turn 217, turn 218, and turn 219], wherein each turn is a tuple consisting of: {turn number, timestamp, content}. Turn numbers (i.e., turn numbers 220A, 220B, and 220C) represent the sequential position of the turn in the dialogue, and time stamps (i.e., time stamp 225A, 225B, and 225C) capture the time the message was published on the social media platform, and contents (i.e., contents 230A, 230B, and 230C) are the textual message(s). The turn numbers are contained within grouping 220; the time stamps are contained within grouping 225; and the content are contained within grouping 230. The sequential position of the turns of the dialogue (between customer 205 and business 210) is: turn 217 is the first position of the dialogue, which is associated with customer 205 and thus indicative of turn 217 as being the first dialogue in a temporal sense; turn 218 is the second position of the dialogue, which is associated with business 210 and thus indicative of turn 218 as being the second dialogue in a temporal sense; and turn 219 is the third position of the dialogue, which is associated with customer 205 and thus indicative of turn 219 as being the third dialogue in a temporal sense. The tuple for turn 217 is: {turn number 220A, time stamp 225A, content 230A}; the tuple for turn 218 is: {turn number 220B, time stamp 225B, content 230B}; and the tuple for turn 219 is: {turn number 220C, time stamp 225C, and content 230C}.

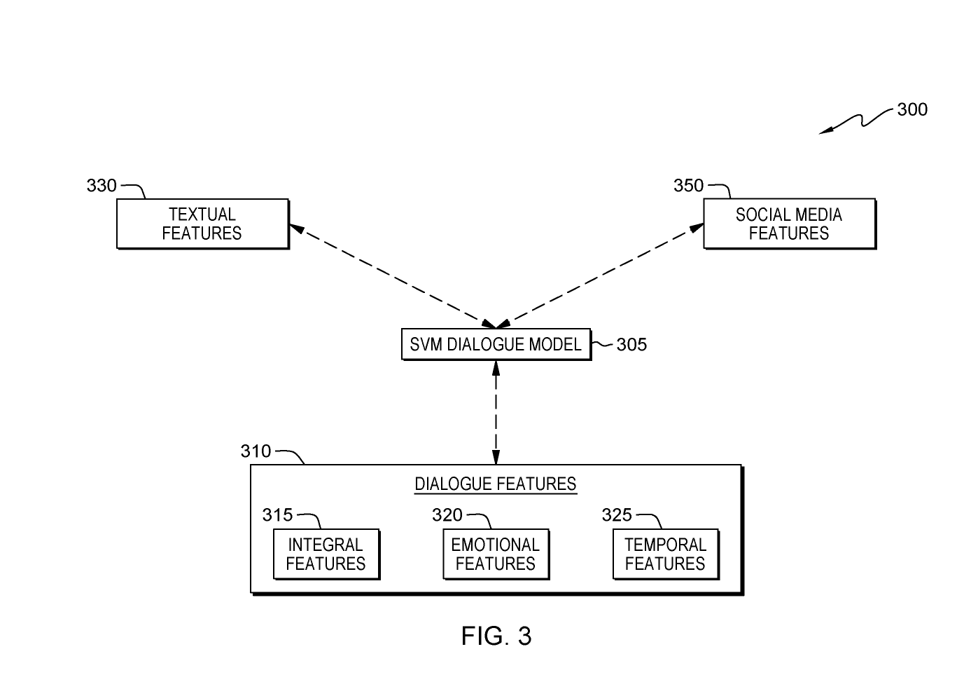

FIG. 3 is a functional block diagram illustrating a dialogue model, in accordance with an embodiment of the present invention.

Environment 300 depicts the data processing environment of a dialogue model.

SVM dialogue model 305 is applied by dialogue program 115 to detect “actions” and “emotions.” SVM dialogue model 305 is a support vector machine (SVM) classifier for a determined emotion class. SVMs are supervised learning models with associated learning algorithms which analyze data classification and regression analysis. SVMs construct a hyperplane or set of hyperplanes in a high- or infinite-dimensional space, which permits data analysis and regression analysis. The hyperplanes are defined as the dot product of the set of points with a vector in the space of the hyperplane. A feature vector, which is used to represent a turn, incorporates dialogue, social, and textual features. SVM dialogue model 305 does not receive raw data. Instead, SVM dialogue model 305 receives pre-processed data which outputs features. These features are the input for SVM dialogue model 305. After SVM dialogue model 305 is trained by an end-user, a turn is classified by: (i) inputted textual features for each turn from textual features 330; (ii) inputted temporal features using time elapsed values between previous turns from dialogue features 310; and (iii) calculated social features from social media features 350 for a given customer ID based on the customer profile and open data (e.g., tweets, re-tweets, and the number of followers of a customer on a social media site).

Dialogue features 310 comprise three contextual feature families: integral features 315, emotional features 320, and temporal features 325. By analyzing a dialogue between the customer and the business, dialogue program 115 extracts features from the dialogue and sends them to integral features 315, emotional features 320, and temporal features 325. A feature may be classified as: global (i.e., a value associated with a constant across an entire dialogue); local (i.e., a value associated with a change at each turn in the dialogue); or historical (i.e., a family of emotional features and local integral features such as agent emotions, customer emotions, and agent essence). Historical features do not include the turn number of previous turns.

Integral features 315 is a family of features which includes three sets of sub-features: (i) dialogue topic; (ii) agent essence; and (iii) turn number. Dialogue topic is a set of global binary features representing the intent of the customer who initiated a support inquiry. Multiple intents can be assigned to a dialogue from a taxonomy of popular topics, which are adapted to the specific service. For example, popular topics of interest for a support inquiry for a stock trading platform include account issues, payments, technical problems, etc. Agent essence is a set of local binary features which represent the action used by the agent to address the last customer turn, independent of any emotional technique expressed. These actions are referred to as the essence of the agent turn. Multiple essences may be assigned to an agent turn from a predefined taxonomy. For example, “asking for more information” and “offering a solution” are possible essences. Turn number is a local categorical feature representing the number of the turn.

Emotional features 320 is a family of features which includes two sets of sub-features: (i) agent emotion; and (ii) customer emotion. Agent emotion is a set of local binary features which represents agent emotion techniques predicted for previous turns. Dialogue program 115 generates predictions of emotion technique for each agent turn, and uses these predictions as one of the features to classify a current customer or agent turn with an emotion expression. Customer emotion is defined analogously to the agent emotion feature set by capturing customer emotions detected in previous turns as a feature for classification of a current turn.

Temporal features 325 is a family of features which includes the sub-features extracted from the timeline of the dialogue: (i) agent response time; (ii) customer response time; (iii) median customer response time; (iv) median agent response time; and (v) day of the week the dialogue took place. Agent response time is a local feature which indicates the time elapsed between the timestamp of the last customer turn and the timestamp of the subsequent agent turn. This is a categorical feature with values of low, medium, or high response time. A low response time is indicative of an efficient or fast response as opposed to a high response time, which is indicative of an inefficient or slow response time. A medium response time is indicative of an “intermediate” response whichis not a fast response time or a slow response time. Customer response time is the time elapsed between the timestamp of the last agent turn and the timestamp of the subsequent customer turn. This is a local categorical feature with values of low, medium, or high response time. Median customer response time is: a local categorical feature defined as the median of the customer response times preceding the current turn; and a local categorical feature with low, medium, or high response time. Median agent response time is a local categorical feature defined as the median of agent response times preceding the current turn. Day of the week the dialogue took place is a local categorical feature which indicates the day of the week when the turn was published (e.g., the span of days when the turn was published).

Social media features 350 capture the activity level and determine “popularity” of the customer as seen in a social media platform. A determination of popularity of the customer depends on at least one of the following: (i) the number of user followers on a social media platform (i.e., the number of other users of the social media platform who are following the customer); (ii) the number of users being followed by the customer; (iii) the number of the customer posts that were re-tweeted by other users; (iv) the number of dialogue tweets (e.g., posts which a user replies to other users); and a centrality measure such as the Klout score, or re-tweet graph centrality. The centrality measure is a quantitative measure used in part to determine the “popularity” of the customer as seen in the social media platform.

Textual features 330 are inputted features into SVM dialogue model 305, which are inputted from the text of a customer turn. Textual features 330 does not consider the context of the dialogue. Dialogue program 115 applies and analyzes the text in terms on aspects of text which have been shown to be effective for making determinations of emotions within the social media domain. These aspects include: unigrams, bigrams, NRC lexicon features (number of terms in a post associated with different affect labels in NRC lexicon), the presence of exclamation points, the presence of question marks, the presence of Twitter® username, the presence of links to other Internet content, the presence of happy emoticons, and the presence of sad emoticons. Dialogue program 115 uses the extracted features from textual features 330 to generate a baseline model for SVM dialogue model 305.

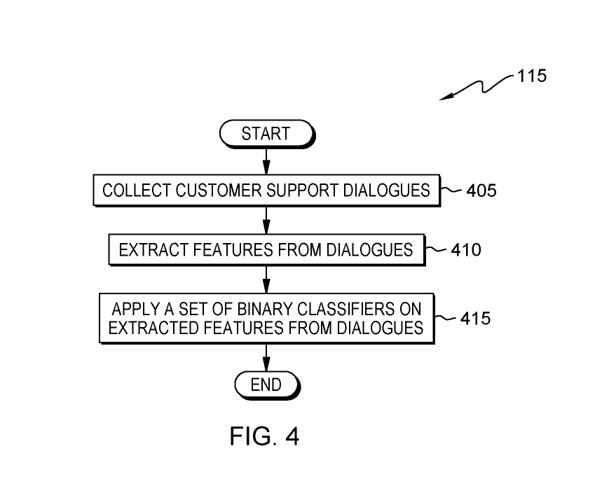

FIG. 4 is an operational flowchart depicting the steps performed by a dialogue program 115 in order to detect emotions in a dialogue, in accordance with an embodiment of the present invention.

In an exemplary embodiment, dialogue program 115 performs the steps in FIG. 4 in order to detect and determine emotions during a customer support session over a social media setting. Dialogue program 115 performs the following: (i) collects customer support dialogues in step 405 (as described in the discussion with respect to FIG. 2); (ii) extracts features from the dialogues in step 410 (as described in the discussion with respect to FIG. 3); and (iii) applies a set of binary classifiers on the extracted features from the dialogues in step 415.

More specifically in step 415, dialogue program 115 performs the following sub-steps for detecting the customer emotions: (i) the implementation of a model (e.g., SVM dialogue model 305) which incorporates all of the feature sets from FIG. 3 (e.g., dialogue features 310, textual features 330, social media features 350); and (ii) treating each turn within the dialogue as multi-labelled classification tasks such that each turn as analyzed by the model may be labelled (or tagged) with multiple emotions. Sub-step (ii) of step 415 captures the notion that a customer can express multiple emotions (e.g., confusion and anger) in a single turn. A “problem transformation approach” is applied, in which dialogue program 115 maps the multi-label classification task into several binary classification tasks—one label for each emotion class which participates in the multi-label problem. For each emotion, a binary classifier is created using the one-versus-all approach, which classifies a turn as expressing the emotion or not expressing the emotion. A test sample is fully classified by aggregating the classification results from all independent binary classifiers. A turn which is classified as not expressing any emotion, is considered as “neutral.”

FIG. 5 depicts a block diagram of components of a computing device, generally designated 500, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 500 includes communications fabric 502, which provides communications between computer processor(s) 504, memory 506, cache 516, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of processors 504 by holding recently accessed data, and data near recently accessed data, from memory 506.

Program instructions and data used to practice embodiments of the present invention may be stored in persistent storage 508 for execution and/or access by one or more of the respective computer processors 504 via cache 516. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Program instructions and data used to practice embodiments of the present invention may be downloaded to persistent storage 508 through communications unit 510.

I/O interface(s) 512 allows for input and output of data with other devices that may be connected to computing device 500. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., software and data, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience and thus, the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for detecting emotions within a social media setting, the method comprising the steps of:
collecting, by one or more processors, contents of a dialogue between a first party and a second party;
extracting, by one or more processors, a plurality of features from the contents of the dialogue;
categorizing, by one or more processors, the extracted plurality of features as tuples;
constructing, by one or more processors, a model based on the extracted plurality of features from the contents of the dialogue;
analyzing, by one or more processors, the tuples which contain the extracted plurality of features, as contained within the constructed model; and
determining, by one or more processors, a first emotion associated with the first party and a second emotion associated with the second party by analyzing the tuples which contain the extracted plurality of features, as contained within the constructed model.

2. (canceled)

3. The method of claim 1, wherein extracting the plurality of features of the contents of the dialogue, comprises:
compiling, by one or more processors, social media based features, wherein the social media based features are used to capture a level of popularity of the second party in the social media setting based on an analysis of activities of the second party in the social media setting and the analyzed tuples;
compiling, by one or more processors, textual based features, wherein the textual based features are analyzed based on lexicon features and the analyzed tuples; and
compiling, by one or processors, dialogue based features, wherein the dialogue based features are analyzed for: an integral set of features, an emotional set of features, and a temporal set of features.

4. The method of claim 3, wherein compiling dialogue based features, comprises:
applying, by one or more processors, a first set of global data values, which remain constant during one or more turns within the dialogue, and a first set of local data values, which vary during the one or more turns within the dialogue;
applying, by one or more processors, the first set of global data values to represent one or more intentions of a second party engaged in a conversation with a first party, over a social media setting;
applying, by one or more processors, the first set of local data values to represent an action by the first party to address a most recent turn associated with the second party;
applying, by one or more processors, a second set of local data values, deriving from a binary set, in order to represent and predict emotions of the first party; and
applying, by one or more processors, a third set of local data values, deriving from binary set, in order to represent and predict emotions of the second party.

5. (canceled)

6. (canceled)

7. The method of claim 3, further comprises:
applying, by one or more processors, a binary classification on each turn associated with the second party, wherein the binary classification determines whether the turn contains a particular emotion by identifying the particular emotion from one or more emotions associated with each turn, based on the analyzed tuples.

8. A computer program product for detecting emotions within a social media setting, comprising:
one or more computer readable storage media and program instructions stored on the one or more computer readable storage media, the program instructions comprising:
program instructions to collect contents of a dialogue between a first party and a second party;
program instructions to extract a plurality of features from the contents of the dialogue;
program instructions to categorize the extracted plurality of features as tuples;
program instructions to construct a model based on the extracted plurality of features from the contents of the dialogue;
program instructions to analyze the tuples which contain the extracted plurality of features as contained within the constructed model; and
program instructions to determine a first emotion associated with the first party and a second emotion associated with the second party by analyzing the tuples which contain the extracted plurality of features, as contained within the constructed model

9. (canceled)

10. The computer program product of claim 8, wherein program instructions to extract the plurality of features of the contents of the dialogue, comprise:
program instructions to compile social media based features, wherein the social media based features are used to capture a level of popularity of the second party in the social media setting based on an analysis of activities of the second party in the social media setting and the analyzed tuples;
program instructions to compile textual based features, wherein the textual based features are analyzed based on lexicon features and the analyzed tuples; and
program instructions to compile dialogue based features, wherein the dialogue based features are analyzed for: an integral set of features, an emotional set of features, and a temporal set of features.

11. The computer program product of claim 10, wherein program instructions to compile dialogue based features, comprise:
program instructions to apply a first set of global data values, which remain constant during one or more turns within the dialogue, and a first set of local data values, which vary during the one or more turns within the dialogue;
program instructions to apply the first set of global data values to represent one or more intentions of a second party engaged in a conversation with a first party, over a social media setting;
program instructions to apply the first set of local data values to represent an action by the first party to address a most recent turn associated with the second party;
program instructions to apply a second set of local data values, deriving from a binary set, in order to represent and predict emotions of the first party; and
program instructions to apply a third set of local data values, deriving from binary set, in order to represent and predict emotions of the second party.

12. (canceled)

13. (canceled)

14. The computer program product of claim 10, further comprises:
program instructions to apply a binary classification on each turn associated with the second party, wherein the binary classification determines whether the turn contains a particular emotion by identifying the particular emotion from one or more emotions associated with each turn, based on the analyzed tuples.

15. A computer system for detecting emotions within a social media setting, comprising:
one or more computer processors;
one or more computer readable storage media;
program instructions stored on the computer readable storage media for execution by at least one of the one or more processors, the program instructions comprising:
program instructions to collect contents of a dialogue between a first party and a second party;
program instructions to extract a plurality of features from the contents of the dialogue;
program instructions to categorize the extracted plurality of features as tuples;
program instructions to construct a model based on the extracted plurality of features from the contents of the dialogue;
program instructions to analyze the tuples which contain the extracted plurality of features as contained within the constructed model; and
program instructions to determine a first emotion associated with the first party and a second emotion associated with the second party by analyzing the tuples which contain the extracted plurality of features, as contained within the constructed model

16. (canceled)

17. The computer system of claim 15, wherein program instructions to extract the plurality of features of the contents of the dialogue, comprise:
program instructions to compile social media based features, wherein the social media based features are used to capture a level of popularity of the second party in the social media setting based on an analysis of activities of the second party in the social media setting and the analyzed tuples;
program instructions to compile textual based features, wherein the textual based features are analyzed based on lexicon features and the analyzed tuples; and
program instructions to compile dialogue based features, wherein the dialogue based features are analyzed for: an integral set of features, an emotional set of features, and a temporal set of features.

18. The computer system of claim 17, wherein program instructions to compile dialogue based features, comprise:
program instructions to apply a first set of global data values, which remain constant during one or more turns within the dialogue, and a first set of local data values, which vary during the one or more turns within the dialogue;
program instructions to apply the first set of global data values to represent one or more intentions of a second party engaged in a conversation with a first party, over a social media setting;
program instructions to apply the first set of local data values to represent an action by the first party to address a most recent turn associated with the second party;
program instructions to apply a second set of local data values, deriving from a binary set, in order to represent and predict emotions of the first party; and
program instructions to apply a third set of local data values, deriving from binary set, in order to represent and predict emotions of the second party.

19. (canceled)

20. (canceled)
